(19) United States
(12) Patent Application Publication
(10) Pub. No.: US 2015/0135892 A1
(43) Pub. Date: May 21, 2015

(54) ADJUSTABLE PEDAL ASSEMBLY

(71) Applicant: KSR IP HOLDINGS, LLC, WILMINGTON, DE (US)

(72) Inventor: Frank Vyskocil, Ridgetown (CA)

(21) Appl. No.: 14/546,447

(22) Filed: Nov. 18, 2014

Related U.S. Application Data
(60) Provisional application No. 61/905,474, filed on Nov. 18, 2013.

(51) Int. Cl. G05G 1/40; G05G 1/46; G05G 1/44

(52) U.S. Cl. CPC G05G 1/40; G05G 1/44; G05G 1/46
USPC 74/560

(57) ABSTRACT

The present invention provides for an adjustable pedal assembly using a main plate and upper link along with a motor to adjust the position of the pedal arm as a motor or other driver moves the upper link. As the motor moves the upper link, the link pivots about the main hub and moves the arm from a first position to a second position. The plate of the assembly remains stationary and is operable to hold the motor of the assembly. After the pedal arm is adjusted, the entire pedal arm rotates about the main hub, including the plate.

### CROSS-REFERENCE TO RELATED APPLICATIONS

This utility patent application claims priority from U.S. provisional patent application Ser. No. 61/905,474, filed Nov. 18, 2013, the entire contents of which is incorporated herein in its entirety.

### FIELD OF THE INVENTION

The present invention relates generally to pedals, more particularly, to an adjustable pedal assembly.

### BACKGROUND OF THE INVENTION

Adjustable pedal assemblies for adjusting the position of a pedal arm to accommodate a driver of a vehicle are well known in the prior art. These adjustable pedal assemblies are typically conventional pedal assemblies for providing adjustability of the pedal arm independent of the main pivot point. Examples of these pedal assemblies are illustrated in commonly owned U.S. Pat. Nos. 6,584,871; 6,862,950; 7,114,411; 6,918,318; 5,771,752; 6,389,972; and 6,178,847. Improvements to these pedal assemblies are encouraged to decrease weight and cost of the overall pedal structure. Accordingly, there exists a need in the art to provide an adjustable pedal assembly having fewer parts to reduce size and cost of the overall pedal assembly.

### SUMMARY OF THE INVENTION

The present invention provides for an adjustable pedal assembly using a plate (or main plane) and a link (or upper link) along with a motor to adjust the position of the pedal arm as a motor or other driver moves the upper link. As the motor moves the upper link, the link pivots about a hub and moves the arm from a first position to a second position. The plate of the assembly remains stationary during adjustment and is operable to hold the motor of the assembly. After the pedal arm is adjusted, the entire pedal arm, plate and link rotate about the hub during operation of the pedal.

### BRIEF DESCRIPTION OF THE DRAWINGS

FIG. 1 illustrates a perspective view of the adjustable pedal assembly of the present invention;

FIG. 2 illustrates a side view of the adjustable pedal assembly of the present invention;

FIG. 3 illustrates a top view of the pedal assembly of the present invention;

FIG. 4 illustrates a close up perspective view of the pedal assembly of the present invention in both a first position and a second position;

FIG. 5 illustrates a side view of an alternative embodiment of the pedal assembly of the present invention; and

FIG. 6 illustrates an alternative side view of an alternative embodiment of the pedal assembly of the present invention.

### DETAILED DESCRIPTION OF THE INVENTION

The present invention provides for an adjustable pedal assembly using a main plate and upper link along with a motor to adjust the position of the pedal arm as a motor or other driver moves the upper link. As the motor moves the upper link, the link pivots about the main hub and moves the arm from a first position to a second position. The plate of the assembly remains stationary and is operable to hold the motor of the assembly. After the pedal arm is adjusted, the entire pedal arm rotates about the main hub, including the plate.

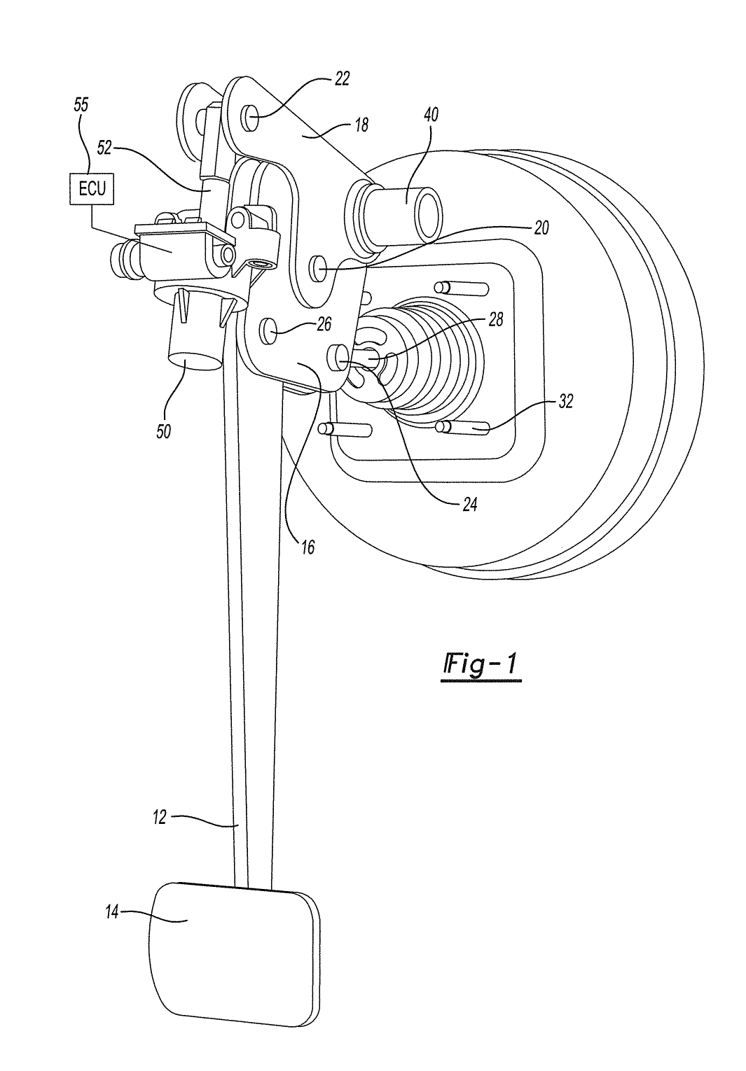

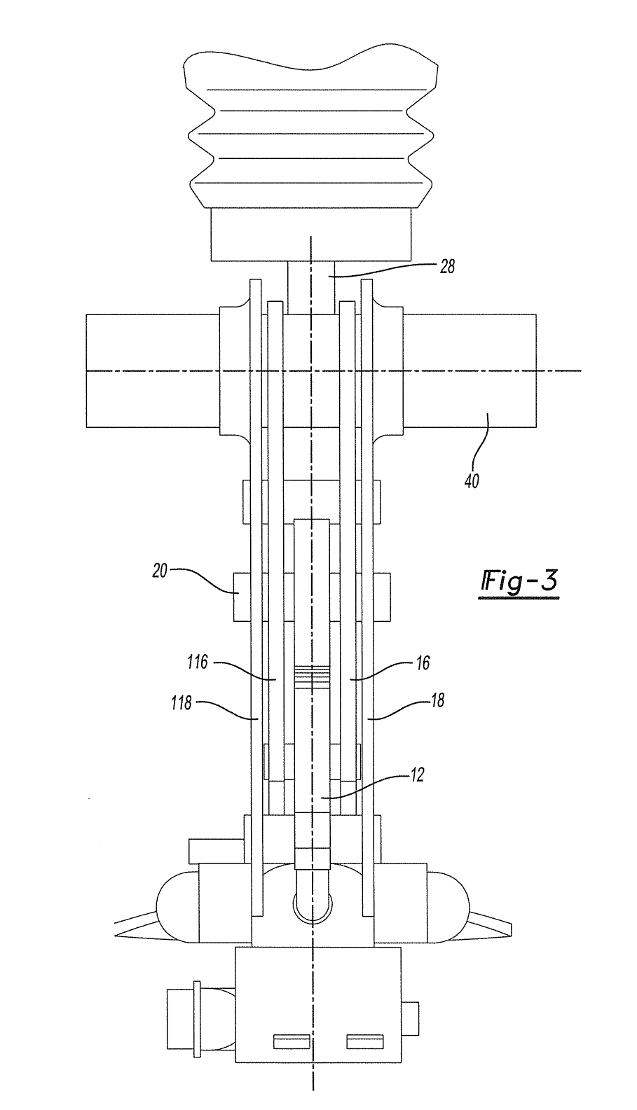

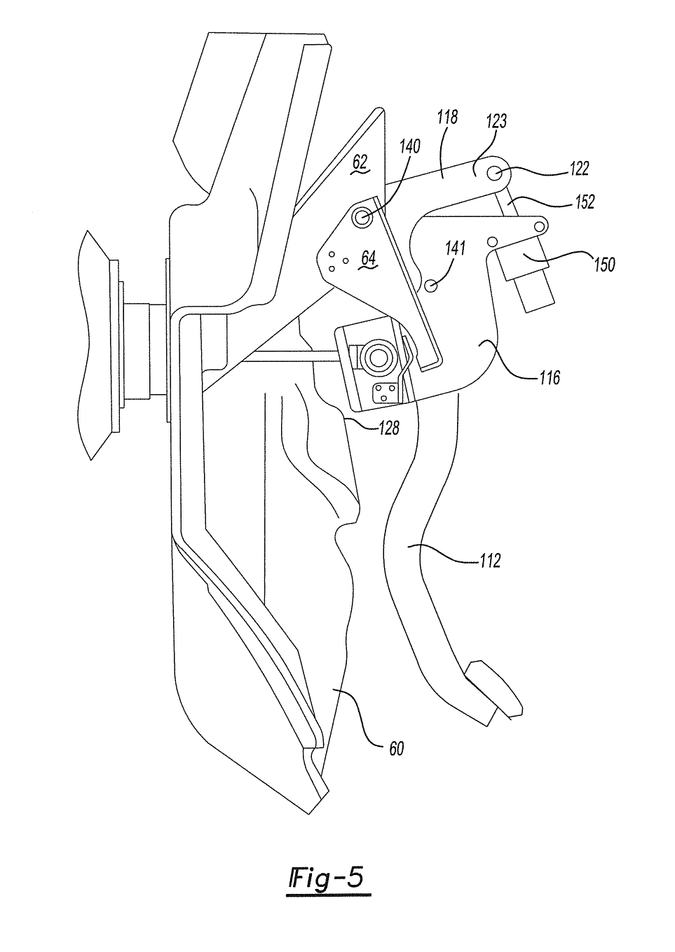

The pedal assembly 10 of the present invention includes a pedal arm 12 having a pedal pad 14. A main plate 16 is provided at an upper portion of the pedal arm 12. The plate 16 is connected to both the pedal arm 12 and a hub 40. The hub connects to a bracket (not shown in FIGS. 1-4—this first embodiment also uses the same bracket as shown in FIGS. 5 & 6 in this first embodiment) which connects to a firewall, body panel or other vehicle part (again, not shown in FIGS. 1-4, however, the same firewall/vehicle/body panel 60 is also used in this first embodiment). The plate, or plates 16 extend on either side of the arm 12. The plate 16 includes a plurality of apertures and connector bolts 20, 24, 26 connecting various components of the system. The bolt 24 connects the plate 16 to the brake rod 28. The brake rod 28 then connects to the booster 30 of the vehicle. Various connection bolts 32 are further provided connected to the booster to connect the booster to the vehicle. As the user of the vehicle depresses the pedal arm 12, the braking desire is transmitted through the braking rod 28 to the braking system. The bolt or fastener (or first connection point) 26 connects an upper end of the pedal arm 12 to the plate 16.

The plate 16 further includes an aperture 21. The aperture 21 is provided generally in the center within the plate 16. A bolt (or second connection point) 20 is provided extending through the plate 16 and through the aperture 21. The bolt 20 connects to both an upper link 18 and the pedal arm 12. As the pedal arm moves from a first position A to a second position B, the bolt moves from the first position A to the second position B. This aperture 21 includes side edges 21a, 21b to prevent extended movement and travel of the pedal arm 12.

After adjustment of the pedal arm 12, the pedal arm 12 is locked into place and is able to rotate about the hub 40. The hub 40 is connected to both the plate 16 and to the link 18.

The upper link 18 includes a three-point connection. The main pivot point of the link 18 is at the hub 40. As the motor moves the elongated end 23 of the link 18 upwards, the link 18 pivots about the hub 40 and moves the pedal arm 12 from a first position A to a second position B.

The motor 50 includes a push rod 52 allowing the motor 50 to move the link upwards or downwards thereby allowing the link to rotate about the hub 40. The motor 50 is connected to an ECU 55 to control movement within the motor.

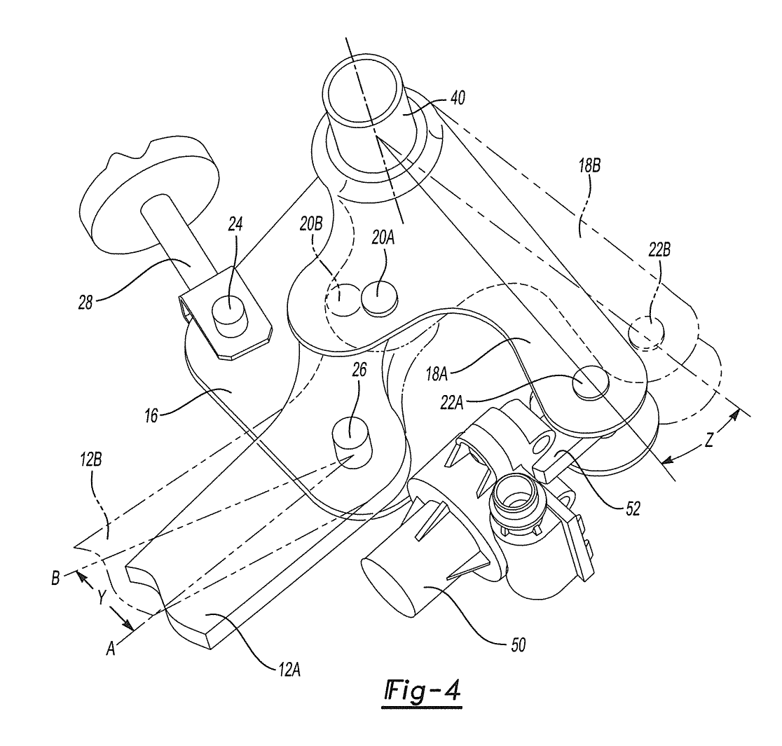

The pedal arm 12, as illustrated in FIG. 4, is operable to move from a first position A to a second position B. The pedal arm 12 may be adjusted at any position between the first position A and the second position B. The pedal arm 12 is operable to move at a distance Y which is up 65 mm to accommodate the needs of the user. Furthermore, also illustrated in FIG. 4, the upper link 18 can be adjusted a distance Z. The distance Z is up to 16 millimeters. The displacement Z is directly proportional to the distance Y, both illustrated in FIG. 4.

Position A is designated by the main plate 16 (stationary), the upper link 18A, the pedal arm 12A, the connection point 22A and the connection point 20A. In position A, the pedal arm is in the forward most position, as illustrated by position A.

Position B is designated by the main plate 16 (stationary), the upper link 18B, the pedal arm 12B, the connection point 22B and the connection point 20B. In position B, the pedal arm is in the rearward most position, as illustrated by position B. The pedal arm is adjusted to position B from position A as the actuator 50 and push rod 52 push upwards on the upper link 18 (or 18A, 18B). The upper link 18 rotates about the hub 40, move the connection point 20 from position 20A to 20B and causes the pedal arm to rotate about the connection point 26 thereby rotating the pedal arm 12 to a position B. The rotation of the pedal arm occurs about the connection point 26. Movement in the opposite direction (from B to A) occurs in the exact opposite movement. This movement is all clearly illustrated in FIG. 4.

A first position A and second position B are illustrated in FIG. 4. The pedal can also be adjusted to any position between A and B.

An Electronic Control Unit, or ECU, is any embedded system that controls one or more of the electrical system or subsystems in a motor vehicle. Types of ECU include electronic/engine control module (ECM), powertrain control module (PCm), transmission control module (TCM), brake control module (BCM or EBCM), central control module (CCM), central timing module (CTM), general electronic module (GEM), body control module (BCM), suspension control module (SCM), control unit, or control module. Taken together, these systems are sometimes referred to as the car's computer. (Technically there is no single computer but multiple ones.) Sometimes one assembly incorporates several of the individual control modules (PCM is often both engine and transmission). The ECU used in the present invention communicates with the sensor assembly (PWA, Hall chip . . . etc.) in relation to the clutch system. Particularly, a dual clutch system in the present invention.

An adjustable pedal assembly for a vehicle is provided having a pedal arm, a main plate, the main plate pivotable about a first connection point 26. The assembly further includes an upper link, the upper link connected to the pedal arm at a second connection point 20. A hub is provided, both the main plate and the upper link pivotable about the hub upon depression of the pedal arm. An actuator is provided where the actuator pivotally connected to the upper link wherein as the actuator pivots the upper link about the hub the upper link causes the pedal arm to pivot about the first connection point 26.

The second connection point is a pin connected to the pedal arm, the pin extending through both the main plate and the upper link. The second connection point having a slot extending through the main plate, the pin of the pedal arm movable within the slot from a first position to a second position. The first position defined where the upper link is rotated fully upwards, the pin positioned at an upper-most position within the slot. The second positioned defined where the upper link is rotated fully downwards thus moving the pedal arm, the pin positioned at a lower-most position within the slot. The pin can be locked at any positioned between the first position and the second position. The hub is spaced apart from the pedal arm.

The upper link is position so as to overlap the main bracket. The assembly includes two main plates, the two main plates positioned on either side of the pedal arm.

The assembly includes two upper links, the two upper links positioned on either side of the pedal arm. The actuator includes a push rod adapted to push the upper link upwards so as to cause the upper link to rotate about the hub. The main bracket is stationary.

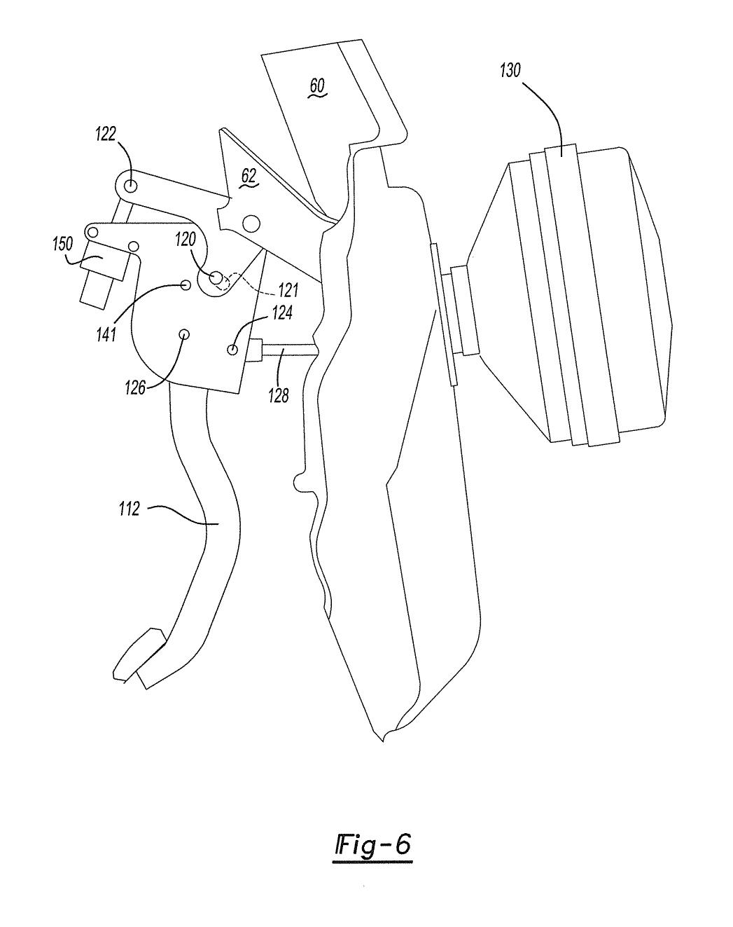

FIGS. 5 and 6 illustrate an alternative embodiment also showing a panel 60 and a bracket 62. The panel 60 is a firewall, body panel, or other vehicle surface. The bracket 62 is adapted to connect to the panel 60. The bracket 62 is further adapted to allow the hub 40, 140 to rotate within it allowing the pedal arm 12, 112 to rotate.

In the embodiment as shown in FIGS. 5 and 6, only stylistic design changes are made. Again the brackets 62 and the panel 60 (and the secondary bracket 64) may also be used in the embodiment as shown in FIGS. 1-4.

The pedal assembly of the embodiment as shown in FIGS. 5 and 6 includes a pedal arm 112 having a pedal pad 114. A main plate (or plate) 116 is provided at an upper portion of the pedal arm 112. The plate 116 is connected to both the pedal arm 112 and a hub 140. The hub connects to a bracket 60 which connects to a firewall, body panel or other vehicle part 60. The plate, or plates 116 extend on either side of the arm 112. The plate 116 includes a plurality of apertures and connector bolts 120, 124, 126 connecting various components of the system. The bolt 124 connects the plate 116 to the brake rod 128. The brake rod 128 then connects to the booster 130 of the vehicle. As the user of the vehicle depresses the pedal arm 112, the braking desire is transmitted through the braking rod 128 to the braking system. The bolt or fastener (or first connection) 126 connects an upper end of the pedal arm 112 to the plate 116.

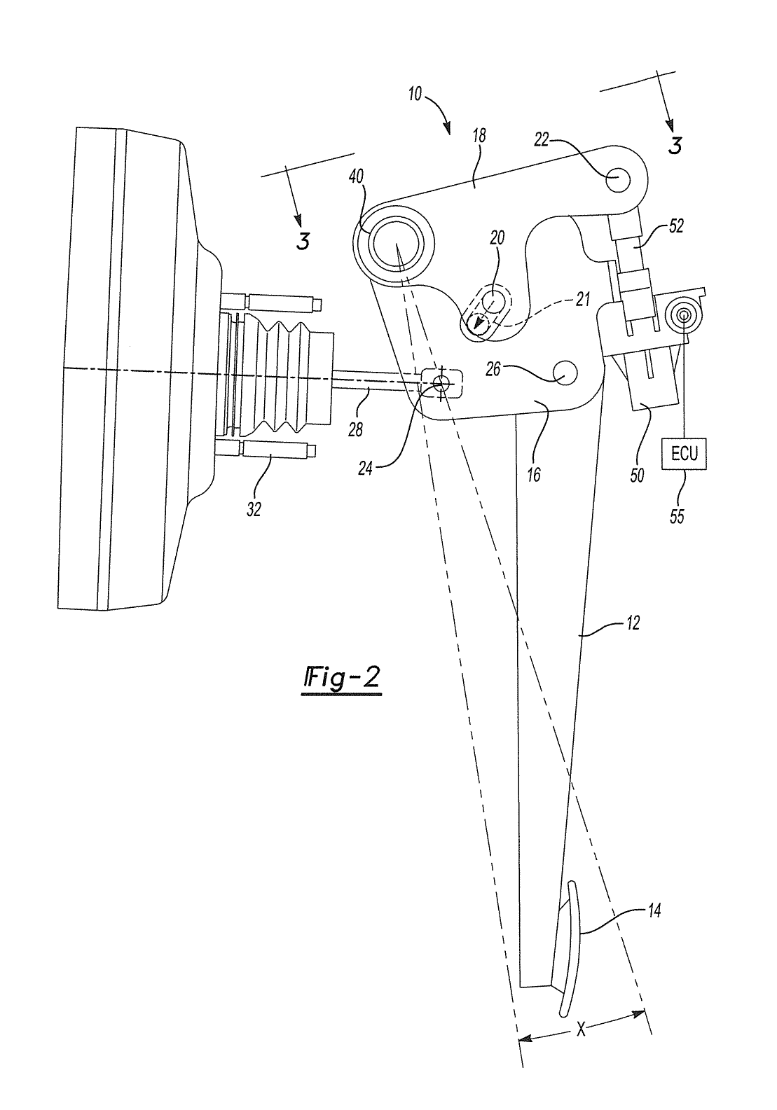

The plate 116 further includes an aperture (or slot) 121. The aperture 121 is provided generally in the center within the plate 116. The connector or bolt (second connection) 120 is provided extending through the plate 116 and through the aperture 121. The bolt 120 connects to both an upper link 118 and the pedal arm 112. As the pedal arm moves from a first position to a second position (seminar to the movement as shown in FIG. 4), the bolt moves from the first position to the second position (again, just as shown in FIGS. 2 and 4.

After adjustment of the pedal arm 112, the pedal arm 112 is locked into place and is able to rotate about the hub 140. The hub 140 is connected to both the plate 116 and to the link 118.

The upper link 118 includes a three-point connection. The main pivot point of the link 118 is at the hub 140. As the motor moves the elongated end 123 of the link 118 upwards, the link 118 pivots about the hub 140 and moves the pedal arm 112 from a first position to a second position (again, similar movement as shown in FIG. 4).

The motor 50 includes a push rod 152 allowing the motor 150 to move the link upwards or downwards thereby allowing the link to rotate about the hub 140. The motor 50 is connected to an ECU 55 to control movement within the motor.

The pedal arm 112 is operable to move from a first position A to a second position B. The pedal arm 112 may be adjusted at any position between the first position and the second position. Again, this movements is comparable to the movement as illustrated in FIGS. 2 and 4 of the first embodiment.

The invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the appended claims.

1. An adjustable pedal assembly for a vehicle, the pedal assembly comprising:
a bracket connected to the vehicle, a plate rotatably connected to the bracket;
a pedal arm pivotable about a first connection point, the first connection point connecting the pedal arm to the plate;
a link connected to the pedal arm at a second connection point;
a hub connected to the bracket, both the plate and the link pivotable about the hub upon depression of the pedal arm; and
an actuator pivotally connected to the upper link;
wherein as the actuator pivots the link about the hub the link causes the pedal arm to pivot about the first connection point.

2. The pedal assembly of claim 1 wherein the second connection point is a pin connected to the pedal arm, the pin extending through both the plate and the link.

3. The pedal assembly of claim 2 wherein the second connection point having a slot extending through the plate, the pin of the pedal arm movable within the slot from a first position to a second position.

4. The pedal assembly of claim 3 wherein the first position defined where the link is rotated fully upwards, the pin positioned at an upper-most position within the slot.

5. The pedal assembly of claim 3 wherein the second positioned defined where the link is rotated fully downwards thus moving the pedal arm, the pin positioned at a lower-most position within the slot.

6. The pedal assembly of claim 3 wherein the pin can be locked at any positioned between the first position and the second position.

7. The pedal assembly of claim 1 wherein the hub spaced apart from the pedal arm.

8. The pedal assembly of claim 1 wherein the link is positioned so as to overlap the plate.

9. The pedal assembly of claim 1 wherein the assembly includes two plates, the two plates positioned on either side of the pedal arm.

10. The pedal assembly of claim 1 wherein the assembly includes two links, the two links positioned on either side of the pedal arm.

11. The pedal assembly of claim 1 wherein the actuator includes a push rod adapted to push the upper link upwards so as to cause the upper link to rotate about the hub.

12. The pedal assembly of claim 1 wherein the plate is stationary during adjustment.

13. The pedal assembly of claim 12 wherein the plate rotates with respect to the hub during normal operation of the pedal arm.
